(19) United States
(12) Patent Application Publication
(10) Pub. No.: US 2004/0024776 A1
(43) Pub. Date: Feb. 5, 2004

(54) Teaching and learning information retrieval and analysis system and method

(75) Inventors: Deborah Moore, Aquinnah, MA (US); Brian Yennie, Jacksonville, FL (US); Irwin Freedman, East Sandwich, MA (US)

Correspondence Address: HALE & DORR LLP, THE WILLARD OFFICE BUILDING, 1455 PENNSYLVANIA AVE, NW, WASHINGTON, DC, 20004, US

(73) Assignee: QLD Learning, LLC, Madison, WI

(21) Appl. No.: 10/629,603

(22) Filed: Jul. 30, 2003

Related U.S. Application Data
(60) Provisional application No. 60/399,131, filed on Jul. 30, 2002.

(51) Int. Cl. G06F 17/00

(52) U.S. Cl. 707/102

(57) ABSTRACT

A system and method for managing content utilizes a relational database management system, which organizes materials such as curriculum materials into, for example, an organizational hierarchy. The system and method allows a user to align materials to a variety of standards including, for example, local, school district, state, and national standards. The system and method also enables a user assess student performance to determine which areas of a curriculum are meeting standards and which require improvement and modification. The system and method further enables the user to assess the effectiveness of a curriculum and curriculum materials by integrating student performance data with such factors as curriculum materials used, assignment histories, and student profile data. Assessment of student performance may also be achieved by integrating data from a first plurality of different user-sites, for example, a first plurality of schools within a school district or a first plurality of school districts within a state.

### CROSS REFERENCE TO RELATED APPLICATIONS

This application claims priority from U.S. Provisional Application Serial No. 60/399,131, filed Jul. 30, 2002 and is incorporated herein by reference in its entirety.

### FIELD OF THE INVENTION

The present invention relates generally to an information retrieval and analysis system and method and more particularly, to a teaching and learning information retrieval and analysis system and method whereby users can create, retrieve, organize, analyze, and share content containing concepts, skills and related information, and can integrate this data with data from other related data systems.

### BACKGROUND OF THE INVENTION

Standards-based education has become a widely adopted practice both in the private corporate sector as well as in the PreK-College education sector. In general, standards are written that describe the concepts and skills that an employee-in-training (corporate sector) or a student (education sector) should know and be able to do, related content is aligned to complex standard matrices, and students are tested as to their level of understanding of these standards. Standards have been created both in-house and by outside entities. For example, the field of engineering has industry standards and in-house standards set by corporations that create training programs for engineers. In Kindergarten through twelfth grade education, there are now over 250,000 academic state and federal standards as well as individual school and school district standards that oversee student performance. To insure that schools implement standard-based education, the federal government has enacted strict legislation, such as the “No Child Left Behind” Elementary and Secondary School (ESEA) Act of 2002, which mandates standards-based assessment of student progress in schools.

Over the years, education publishers, schools, corporate training companies and various other corporations have accumulated large amounts of content containing concepts, skills and related information. Today's content users require that the content be aligned to standards. For example, a school district might require content alignment to school district standards, state standards, and national standards. This level of content management necessitates the use of a software alignment process that accurately and quickly aligns high volumes of content to high volumes of multiple standard matrices. Past and current software systems do not contain such alignment processes. Specifically, they offer simple direct alignment or semi-automated alignment processes for relating content to standards. In the case of the simple direct alignment process, the user creates the data associations by manually reading each content component and each standard. The software provides keyword text searches as a means of more quickly locating standards and content, displays the different items found on a computer screen for the user's review, and saves data content/standard configurations created by the user. This process has proven to be far too slow for organizing high volumes of content and standard data and for handling the frequent modifications made to both content and standards. FIG. 1 visually represents the magnitude of this process by showing the number of links that result from aligning only a few documents to a few state standards from Florida, Connecticut, Vermont, and Texas.

To reduce the time spent aligning content and standards, indirect alignment processes were created where a central database is pre-aligned to standard matrices. In this process, content is aligned to the central database and inherits the alignments to all of the standards pre-aligned to that database. When an indirect alignment process tries to handle a high volume of standard matrices that vary in the concepts and skills they contain and in how those concepts and skills are organized, the result is a high number of alignment errors. The indirect alignment process also removes the user from being able to easily see the actual standards. Quality is thus sacrificed to save time. FIG. 2 illustrates the alignment of an activity, called “Ramps” to state standards. Ramps contains the concepts 1,10, and 11. Via concept 1, “Ramps” is aligned to “Intermediary #1” in the central database, which contains concepts 1,3 and 4. The result is that “Ramps” inherits alignments to standards that match Intermediary #1's concepts 3 and 4. Concepts 3 and 4 are not present in “Ramps”. Furthermore, Ramps has inherited links to concepts 5, 7 and 8, which are present neither in the activity nor the intermediary. In an ideal alignment, Ramps would be aligned directly to its concepts preserved as individual content pieces that together form the standards, thus capturing an exact alignment yet also obtaining information about the relevant standards to which the concept belong.

In recent years, users of content have increasingly obtained their content from multiple sources. Existing software systems do not accommodate the integration of multiple source content and standards at the concept/skill level. Content from different sources may vary greatly in specificity, organization, depth and approach. Even within a single publishing house or school district there may be minimal content consistency. Past and current software systems tend to cater to a particular format possibly derived from a preferred method of teaching, or in other cases based on the format of standards (or both). The problem with this approach is twofold. First, content is not easily mixed; for example, a software system that works well for a set of highly specific assessment tasks may fail when presented with a set of broad goals and learning objectives. Secondly, the system is vulnerable to change; if the content is updated over time and takes on a new format, the system may become just as vulnerable.

### SUMMARY OF THE INVENTION

The system and method of the present invention provides a general alignment process for rapidly aligning any given set of standards, for example, a school's district student learning objectives, to any other set(s) of standards, for example, state and national student learning standards. The present invention enables both direct and indirect alignment. The present invention utilizes several alignment strategies, including, for example, relevance-ranking technology, document routing technology, key term(s) determination, related term(s) identification, and free-form keyword searches. The present invention also creates an integrated, organized database of content, which could be, for example, a corporation's instructional, planning, implementation and assessment data, and further could be, for example, a school district's instructional, planning and assessment curriculum materials used to teach students, allowing the data to be accurately aligned with related learning standards.

The present invention provides a method for managing content. The method includes maintaining an alignment system wherein the alignment system stores content data. The method also includes receiving a request, from at least one user, by the alignment system to align the content to one or more a first plurality of standards using the alignment system. The method further includes performing the alignment using the alignment system.

The present invention also provides a system for managing content. The system includes a relational database management system, which defines a first plurality of data tables. The first plurality of data tables comprises at least part of the content. The system also includes at least one server in communication with the relational database management system. The at least one server controls access to the relational database management system. The at least one server also controls retrieval of and modification to the content contained in the first plurality of data tables. The system further includes an interface that receives a request from at least one user to access the relational database management system wherein the interface receives the request from the at least one user over a wide area network.

Additionally, the present invention provides a computer-readable medium having a set of computer-executable instructions for managing content. The instructions include receiving a request from at least one user to align the content to at least one a plurality of standards using a alignment system wherein the alignment system either stores the content in its entirety or stores some of the content in addition to uniform resource identifier (“URI”) link(s) to additional portions of the content that is stores on separate computer(s) and/or server(s). The instructions also include performing the alignment using the alignment system.

There has thus been outlined, rather broadly, the more important features of the invention and several, but not all, embodiments in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These, together with other advantages of the invention, along with the various features of novelty, which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 illustrates a prior art system for applying a simple direct alignment process to the alignment of massive amounts of data.

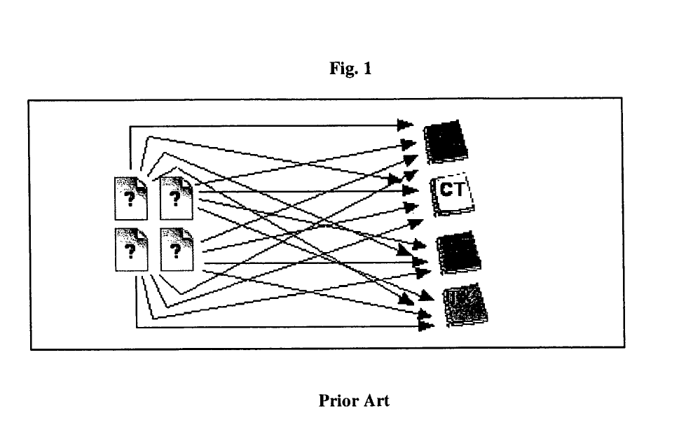

FIG. 2 illustrates a prior art approach to the alignment of an activity to state standards.

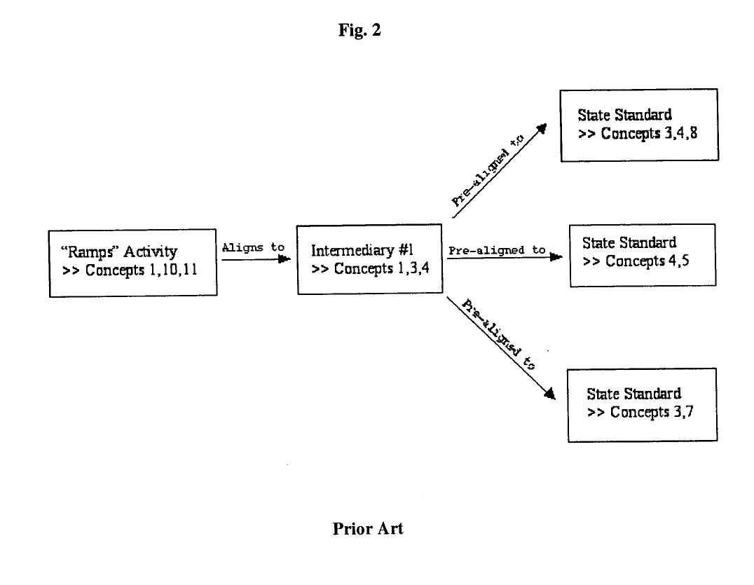

FIG. 3 illustrates a user displaying school district grade 9-10 mathematics objectives for the category, “Data Analysis, Statistics, and Probability.”

FIG. 4 illustrates a user accessing the list of curriculum items that address the specific objective, “Use appropriate statistics (e.g., mean, median, range, and mode) to communicate information about graphically represented data.”

FIG. 5 illustrates the preservation of the format of a content item and integration of said item at the concept/skill level.

FIG. 6 illustrates a user accessing the science activity, “Competition-Natural Selection.”

FIG. 7 illustrates a user creating a mathematics classroom activity called, “Analyzing Data.”

FIG. 8 illustrates that as soon as a new content item (in this case, the activity “Analyzing Data” of FIG. 7) is entered into the database and aligned to specific objectives/standards, the content item will appear on the detailed content lists by objective/standard for each of the objectives/standards aligned to the activity.

FIG. 9 illustrates the ability to enter student performance grades at any level of specificity.

FIG. 10 illustrates one exemplary embodiment of the invention's ability to assign any curriculum material (e.g. activities, tests and homework) to specific students by specific calendar date.

FIG. 11 illustrates an exemplary embodiment of how an RDBMS defines a set of data tables that contain the organizational information necessary to categorize the content and allow it to be easily located.

FIG. 12 illustrates an exemplary embodiment where a GUI (“Graphical User Interface”) is used to access the present invention.

FIG. 13 illustrates the case where the generated GUI provides a logon screen for the user to enter a name and password.

FIG. 14 is a sample of an exemplary DHTML interface with content.

FIG. 15 illustrates the user-display of search results for an exemplary search.

FIG. 16 illustrates the viewing of detailed information pertaining to an activity.

FIG. 17 illustrates an exemplary embodiment of the present invention providing an area in which the user may create links to records in other content areas.

FIG. 18 illustrates an exemplary extension of the processes of the present invention for automated and manual direct alignment in order to facilitate indirect alignment.

FIG. 19 illustrates an exemplary embodiment of standard, which is a parent record to a more specific benchmark standard.

### DETAILED DESCRIPTION

In the following detailed description, numerous specific details are set forth regarding the system and method of the present invention and the environment in which the system and method may operate, etc., in order to provide a thorough understanding of the present invention. It will be apparent, however, to one skilled in the art that the present invention may be practiced without such specific details. In other instances, well-known components, structures and techniques have not been shown in detail to avoid unnecessarily obscuring the subject matter of the present invention. Moreover, various examples are provided to explain the operation of the present invention. It should be understood that these examples are exemplary. It is contemplated that there are other methods and systems that are within the scope of the present invention.

Although use of the present invention in the context of alignment of education materials is presented as an exemplary embodiment, there is no intent to limit the present invention to the educational field or school curriculum alignment. For example, the present invention may also be used to align the goals and objectives of a corporation to marketplace standards, as well as to enable corporate members to link their on-going planning, implementation and assessment data to these standards. These and other applications of the present invention would be readily recognizable and understandable by those skilled in the art as within the scope of the present invention.

The exemplary embodiment of the invention is as a system for creating, organizing, aligning, and assessing educational content and teaching/learning strategies. A primary data management component is the invention's data alignment process which enables any combination of data from any combination of sources to be integrated at a fine level of granularity. The invention's alignment processes are not based on any one alignment paradigm; rather it is a general tool to enable many. For example, in the field of K-12 education, the exemplary embodiment enables the alignment of curriculum content and teaching/learning strategies to multiple sets of school learning objectives and state and national standards.

The invention facilitates creative and collaborative work structures both through its data structure and its computer user-interface designs. Users may create their own integrated data configurations as individuals or as members of a co-authoring group. These configurations may include user-authored data materials. Users may grant access to each other's data materials, co-create new teaching/learning data paradigms, and compare the results of using these new paradigms. For example, in the case of education, teachers across the globe can compare how they are teaching and students are learning specific concepts and skills.

The exemplary embodiment enables the improvement of teaching and learning practices. For example, Kindergarten through graduate level schools may use the invention to create curriculum configurations that address the specific needs of their particular student body. This is accomplished via an on-going cycle of (a) aligning the school's curriculum materials and teaching strategies to local and district student learning objectives as well as to state and national standards, (b) assessing student performance by individual student learning objective and standard, thereby determining the specific areas of the curriculum that need improvement so that local, state, and national student performance levels are met, and (c) implementing improvements in the curriculum based on the assessment results. Using the invention, a school may implement curriculum improvements by authoring new materials and teaching strategies and by modifying existing materials and strategies. A school may also use the invention to integrate newly purchased curriculum materials with their existing curriculum. The result is a system that enables on-going improvement of student, teacher, and overall school performance.

In one or more exemplary embodiments, the invention is a web-based system that enables users to access the system from any computer having Internet access, work in real-time with other people all over the world, and utilize any data accessible via a network such as the Internet. In alternative exemplary embodiments, the invention is a software-based system that can use any commercially available personal computer.

Today's users require a teaching and learning management system that integrates content at the concept/skill level while maintaining the content's original format. This invention meets these requirements. For example, schools may wish to integrate the following content: school-authored student activities and tests, content purchased from education publishers, and state test questions.

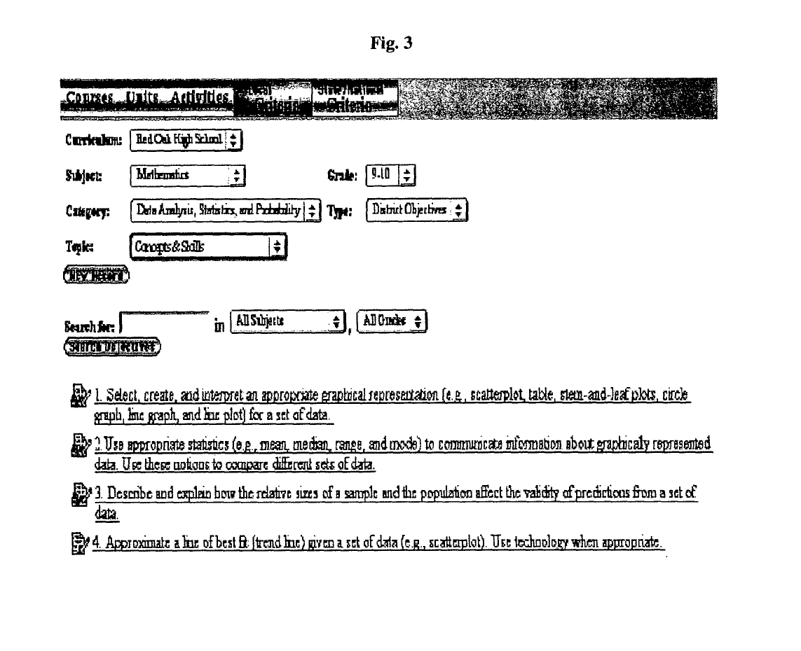

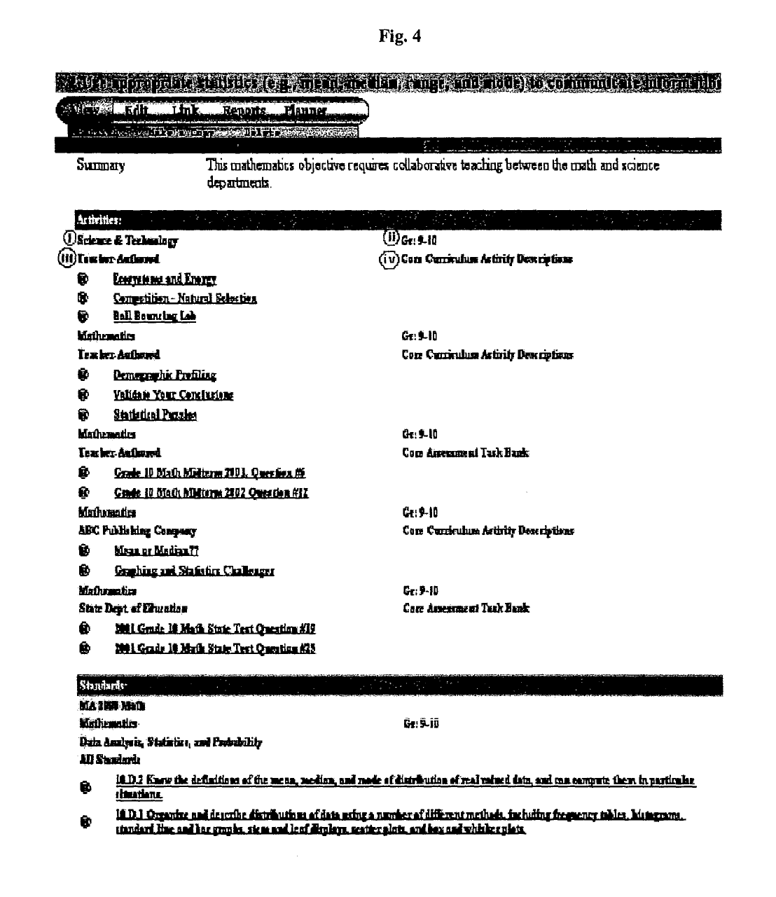

Referring now to the drawings, and initially to FIG. 3, there is illustrated a user displaying school district grade 9-10 mathematics objectives for the category, “Data Analysis, Statistics, and Probability”. User can click on any of the listed objectives and get all curriculum items in the school's data base that address this specific objective; e.g., teacher-authored and purchased classroom activities, teaching resources, test questions, scoring rubrics, and state and national test questions and resources. In FIG. 3, a high school math teacher displays the school district's grade 9-10 student objectives for the category, “Data Analysis, Statistics, and Probability”. Using this objective list, the teacher specifies the concepts/skills he/she wishes to focus on by selecting the second objective, “Use appropriate statistics; e.g., mean, median, range, and mode, to communicate information about graphically represented data. Use these notions to compare different sets of data.” Once the teacher clicks on a chosen objective, the data in FIG. 4 appears; i.e., the teacher is provided with a list of all curriculum items in the teacher's school district database that specifically address the selected mathematics objective. Each content item displayed is labeled as to its (i) subject, (ii) grade level, (iii) author or source, and (iv) its content type. In order of appearance in FIG. 4, the teacher can select from three grade 9-10 teacher-authored core curriculum science activities (“Ecosystems and Energy”, “Competition-Natural Selection” and “Ball Bouncing Lab”), three grade 9-10 teacher-authored mathematics activities, (“Demographic Profiling”, “Validate Your Conclusions”, “and “Statistics Puzzler”), grade 10 math midterm 2001 question #6 and 2002 question #12; two grade 9-10 mathematics activities written by ABC Publishing Company (“Mean or Median??” and “Graphing and Statistics Challenger”), and grade 10 state test questions #19 and #25 for the year 2001. The state standard(s) that relate to the selected district objective also appear.

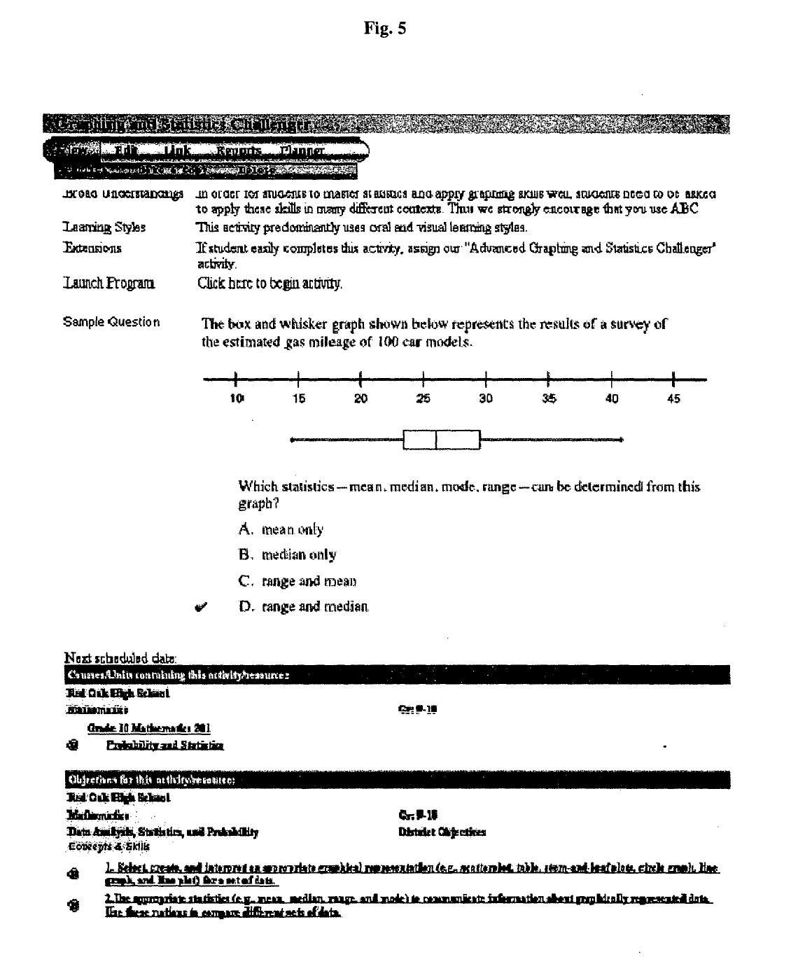

From FIG. 4, the teacher selects, for example, the ABC Publishing Company's activity, “Graphing and Statistics Challenger.” FIG. 5 illustrates the display of this activity. In the illustrated embodiment, the format for this activity is the format designed by ABC Publishing Company.

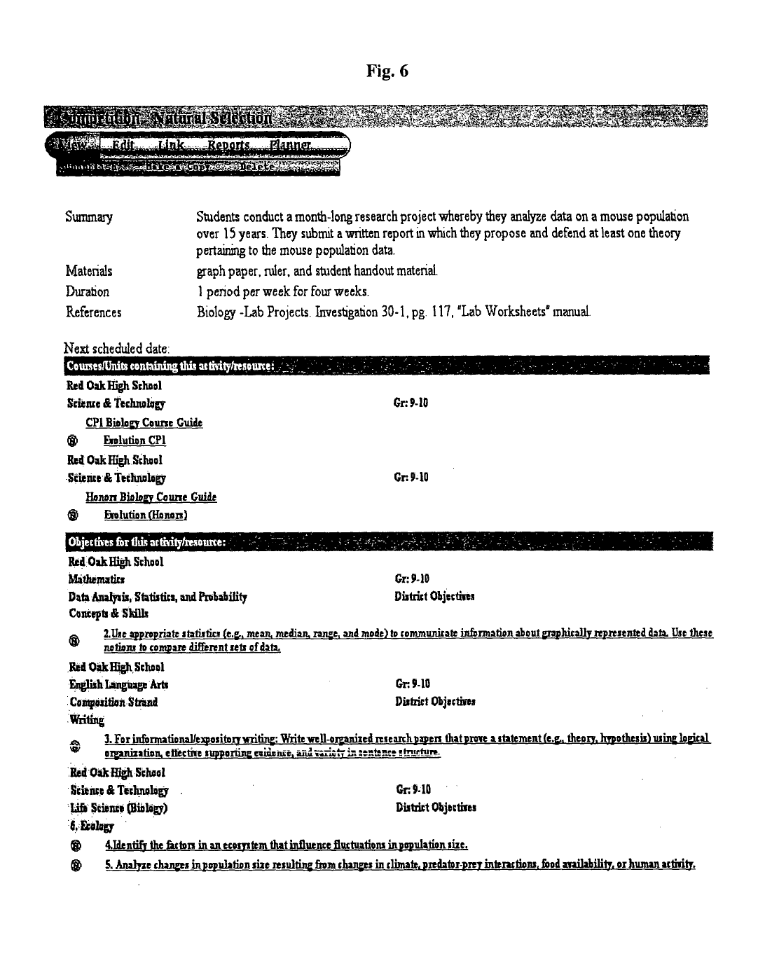

From FIG. 4, the teacher selects, for example, the teacher-authored science activity, “Competition-Natural Selection.” FIG. 6 illustrates the teacher-authored format for this activity. Thus, any user can readily access the two activities illustrated in FIG. 5 and FIG. 6, where both activities teach the same mathematics district objective and both activities have maintained their original content format. Similarly, from a User interface screen such as that illustrated in FIG. 4, a User can select any of the other items that address the selected mathematics objective and can view each of these items in their original content format.

Today's teachers and learners use collaborative work structures whereby they learn from each other, co-create new teaching/learning paradigms, and compare their respective implementation results. For example, math and science grade 9-10 teachers can access objective-specific data via computer screens such as illustrated in FIG. 4 and accurately verify that they have a shared understanding of how to teach and test students for proficiency in a specific student learning objective. School staff members can co-create or individually create additional curriculum resource, align them to any and all concept/skill list (such as the school's district objectives and the school's state standards), and publish them so that all other Users can see them. For example, in FIG. 6, the teachers for the CP1 and Honors courses in Biology co-created the activity, “Competition—Natural Selection”. The display for the activity shows the activity actively being taught in both courses. It has been published so that other Users will be able to access it but not modify its contents. FIG. 6 also shows that this new science activity has been aligned to the Data Analysis, Statistics, and Probability mathematics objective illustrated in FIG. 4 as well as to science and English objectives. A user that selects any of the objectives that are aligned to this activity will find the “Competition-Natural Selection” activity. Thus an English teacher who selects the English objective in the context of an English activity will see the objective's links to activities in other subjects (in this case, science).

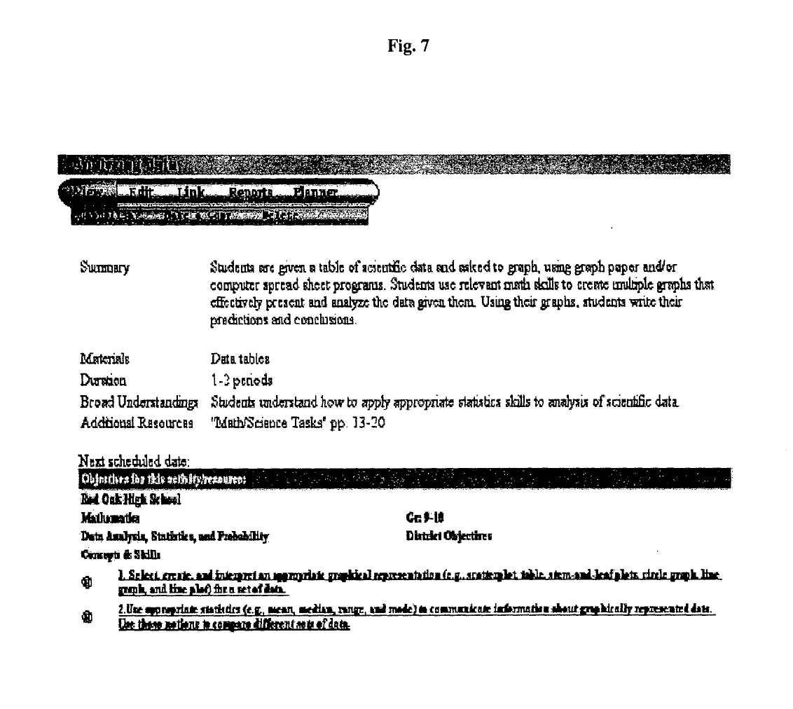

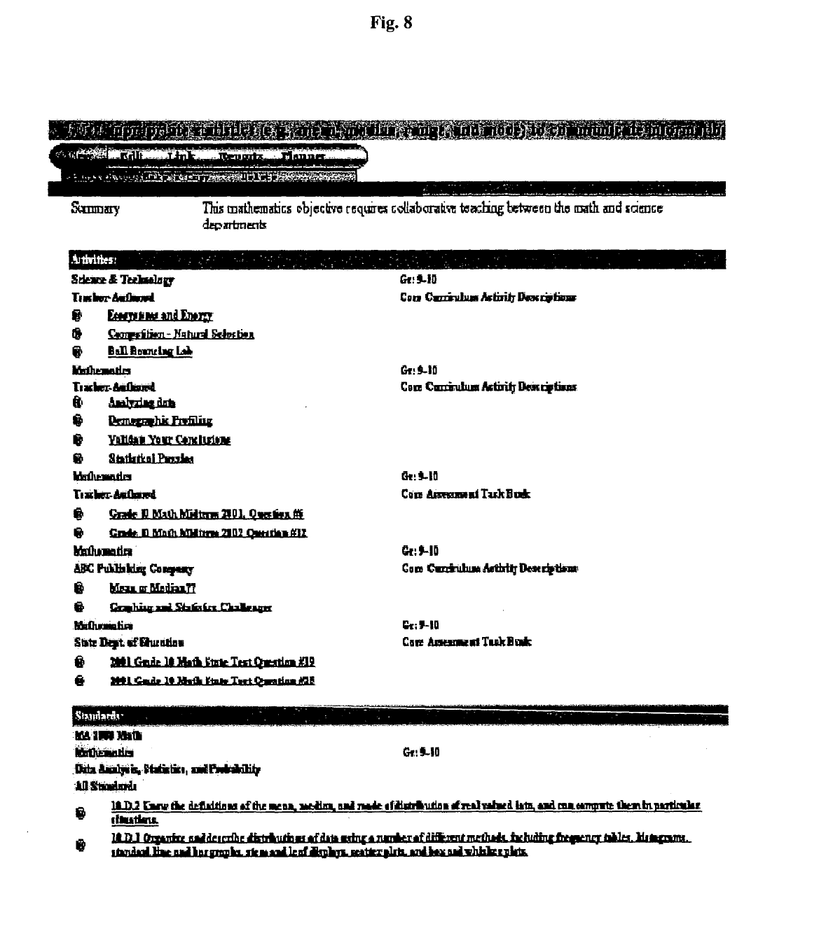

In FIG. 7, an individual teacher, Penny Dyer, entered a new mathematics activity, “Analyzing Data”, aligned the activity to the same Data Analysis, Statistics and Probability mathematics objective, and published the activity so other Users could access the activity. FIG. 7 shows how Mrs. Dyer created her own activity layout, using the sub-headings, “Summary”, “Materials”, “Duration”, “Broad Understandings”, and “Additional Resources”. FIG. 8 shows that the next time any User selects the cited Data Analysis, Statistics, and Probability objective, the new mathematics activity, “Analyzing Data”, will appear along with all of the Content items already in the database, as illustrated in FIG. 4.

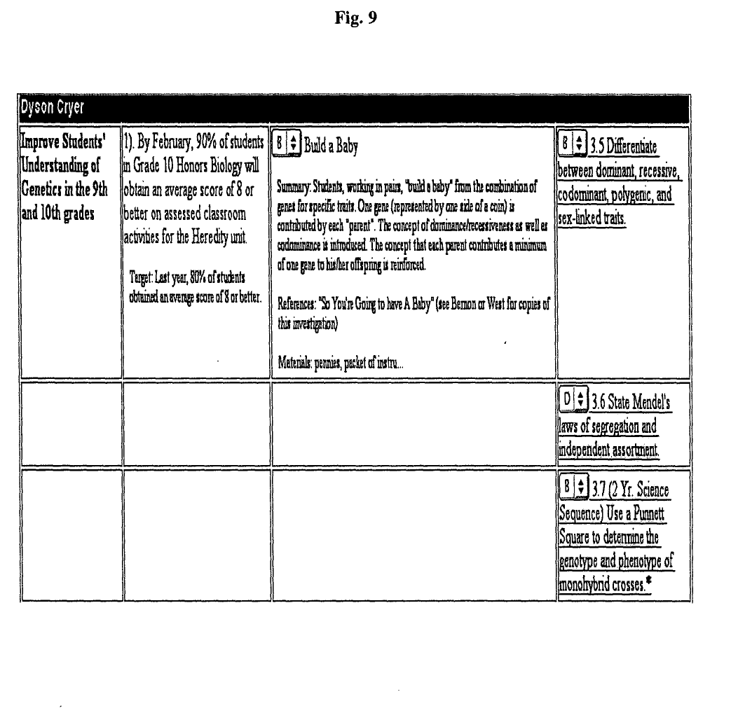

An important component in User-collaboration in creating and sharing effective teaching/learning practices is to validate the success of the practices and share these results. FIG. 9 illustrates entering student performance grades by district performance indicator, by specific classroom activity or test. Users can compare student assessment scores for each student learning objective. Since each student scores is specifically linked to the combinations of teaching strategies, classroom activities, and performance assessment tasks the student experienced, users can ascertain the specific combination of curriculum content and strategies that yielded the best student performance results.

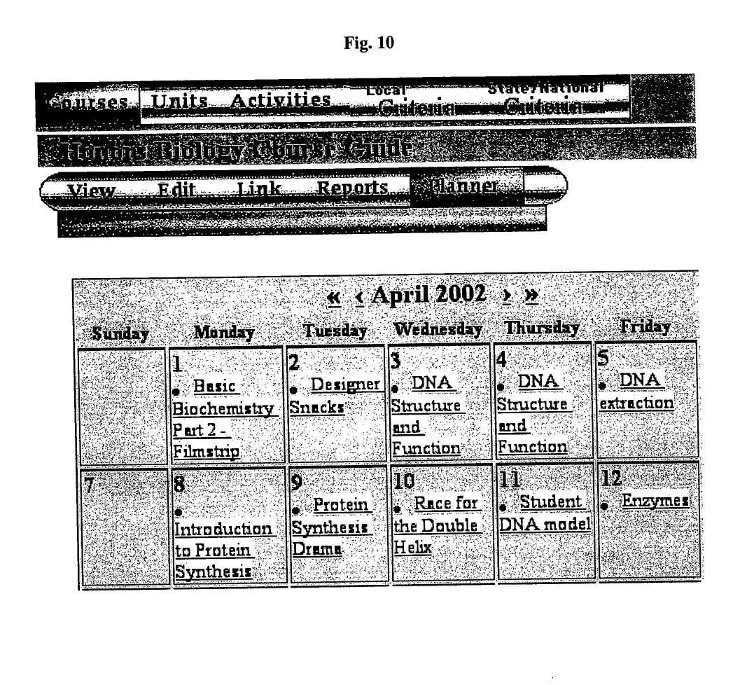

An additional variable in analyzing teaching/learning data is being able to combine the student or learner's experiences in multiple classrooms. FIGS. 4 through 8 exemplify the combining of student experience from taking both math and science courses. FIG. 10 illustrates the invention's ability to assign any curriculum material (e.g., activities, tests, and homework) to specific students by specific calendar date. This additional data logging enables the analysis of curriculum practices that have yielded the highest student performance in terms of the chronological order the activities/tests were administered, how much time was spent on each, and what homework assignments facilitated student learning. By using the invention's ability to integrate student profile data such as student's primary language, community profile (inner city, rural, etc.) with curriculum data, curriculum content configurations that yielded high student performance can be further organized by student profiles. By using the invention's ability to share and integrate student/curriculum data from an infinite number of User-sites, data analysis increases in validity. For example, the student performance/student profile/content configuration data for the entire population of several inner city school districts can be integrated and compared.

Today's marketplace requires a highly sophisticated teaching/learning management system that enables users to create a clear and shared understanding of concepts and skills, assess student learning at the individual concept/skill level, and examine, in-depth, the combinations of content and teaching strategies that yielded the best learning results for specific student profiles. Past and current systems lack the combination of computer user interfaces and database infrastructure necessary to create such a comprehensive teaching/learning management system. This invention's computer screens and database structure enable users to learn from each other's validated curriculum practices (e.g., student performance data is captured and linked to curriculum), and apply their increased knowledge to create and validate other new curriculum practices.

Today's users need a complex teaching and learning system that they can access remotely, that is able to utilize any data accessible via a network such as the Internet, and that is able to work in real-time with people all over the world. Current content management systems do not adequately address these needs. Current systems are best described as content systems with some simple management features. For example, current web-based systems rely on manual alignment processes facilitated by text searches and simple processes for linking content components such as storing each content component's URI, or uniform resource locator (“URL”), address. Thus, although users can access these systems via the Internet, the systems are not providing the database management capabilities needed by the users. Further, these systems do not provide easy integration with other related data systems. This invention is a tool that may be accessed over the Internet, or other computer networks, which provides the sophisticated features users want in a teaching and learning information retrieval and analysis system.

In order to service many users at remote locations, the exemplary embodiment may be implemented in the client/server model. Specifically, in order to deliver the system over a data network such as the Internet, the exemplary embodiment may be implemented through the well known techniques of database and web servers. Hardware configurations may vary to accommodate various amounts of data and access loads, but generally would include dedicated server computers used to serve data over the Internet. In this Internet access scenario, users would access the system through web browsers (or other internet-connected software) on their individual computers.

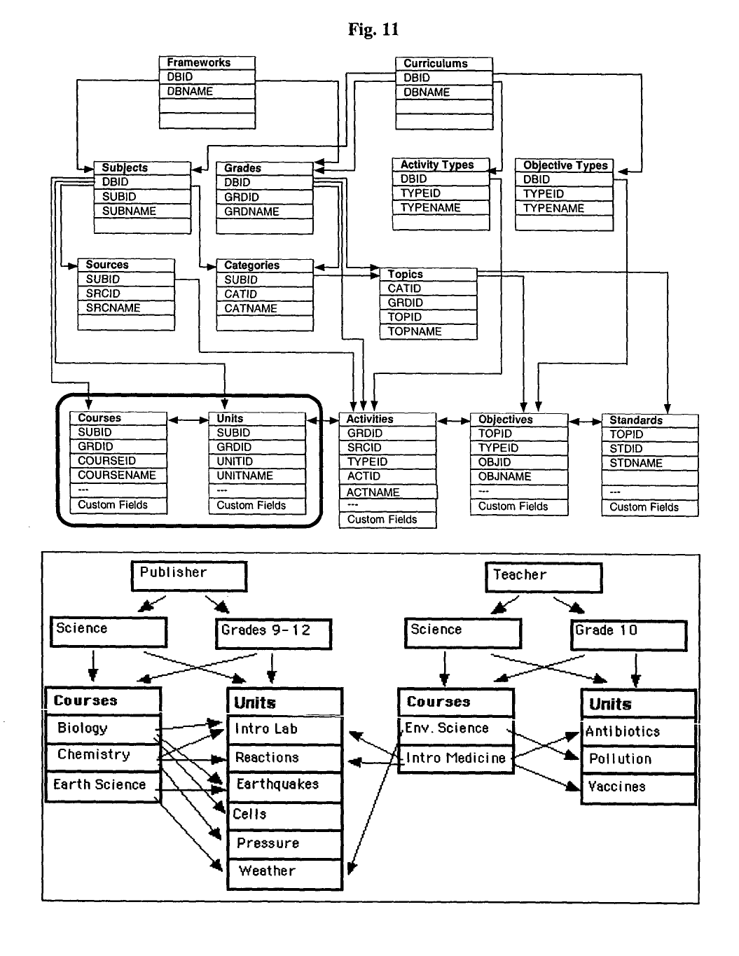

In one embodiment, the RDBMS defines a set of data tables, which contain the bulk of the educational content. In the case of the exemplary embodiment, as illustrated in FIG. 11, there are five such data tables: “Courses”, “Units”, “Activities/Resources”, “Objectives” and “Standards.” Each table, in sequential order, is related to the next by the well-known technique of M:M (“many to many”) database relations. Thus any course may be seen as containing a series of units, which in turn contain any number of activities, which contain any number of objectives, which finally are correlated to any number of standards. Since the relation is M:M and not 1:M (“one to many”), each unit may be shared between more than one course, each activity in more than one unit, and so on and so forth. For example, at the bottom of FIG. 11, the “Intro Lab” unit is shared by a Publisher company's “Biology” and “Chemistry” course, as well as by a teacher-authored course, “Intro Medicine”. Each of the M:M links in the database contains an additional text field in which the user may record notes pertaining to the alignment.

Each record in any of the content-bearing data tables defined above contains (at minimum) a short descriptive record name, a unique ID field, and at least one open-ended text field. The RDBMS system may also provide a means by which users may name their own textual fields. For example, field names for the data type, “Activities” vary significantly; e.g., one activity may use fields “Abstract”, “Detail”, “Evaluation” another activity may use the fields, “Author's Name”, “Learning Style”, “Assessment Rubric”, “Materials”, “Extensions”, “Detail”, and so on. As previously described via FIGS. 5, 6, and 7, user-named textual fields may also play a primary role in enabling the integration of data from different sources, since each source may use an entirely different set of fields. User-named textual fields may be used to provide additional explanation of a data type; for example, users may wish to add a “Standard Notes” field that clearly explains the meaning of industry-set standards whose text cannot be altered.

The RDBMS also defines a set of data tables that contain the organizational information necessary to categorize the content and allow it to be easily located. The number and names of organizational data tables used may vary with each application. In the case of the exemplary embodiment, there are several such tables: “Curricula”, “Frameworks”, “Subjects”, “Grades”, “Types”, “Sources”, “Categories”, and “Topics.” As illustrated in FIG. 11, the “Curriculum” and “Frameworks” tables are the top-level data types, and all other organizational fields fall in a hierarchy under these types. At the bottom of the hierarchy are located the plurality of data tables mentioned above. “Courses”, “Units”, “Activities/Resources”, and “Objectives” fall under a hierarchy headed by the “Curricula” type, while “Standards” fall under a “Frameworks” headed hierarchy. Members of the hierarchy are related moving downward by 1:M database relations. “Subjects”, “Grades”, and “Types” are subsumed by either one record in the “Curricula” table or the “Frameworks”, and thus constitute the second-from-top level of the hierarchy. Under each record from “Subjects” fall “Categories”, and under one record each from “Grades” and “Categories” is the most-specific type, “Topics.”

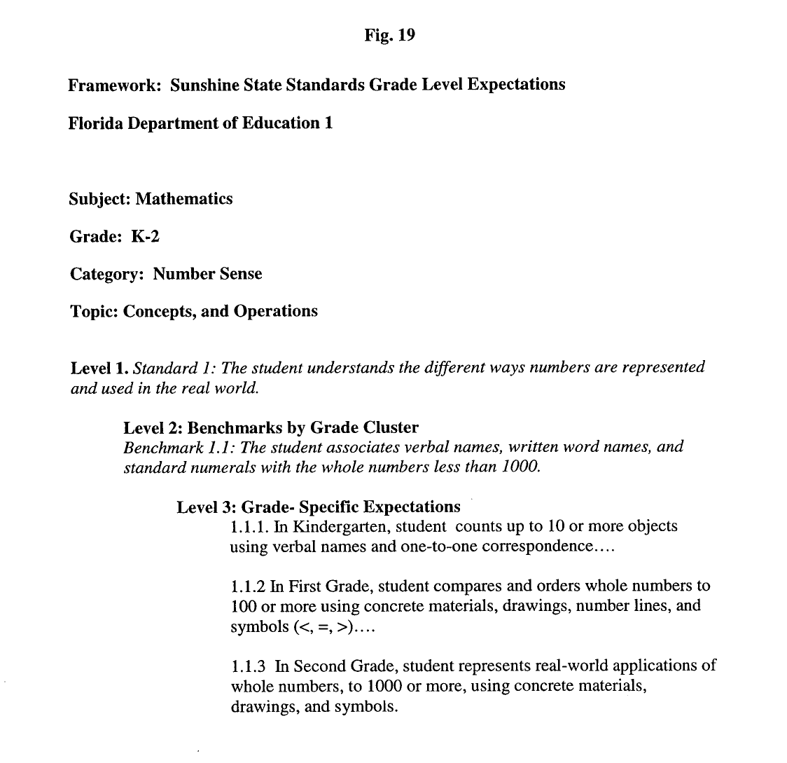

The exemplary embodiment of the present invention takes an additional step to accommodate content needing varying levels of organization. In each of the content tables described above, there is established a 1:M self-relation, in which each record may be the “parent” record for any number of other records in the same table. As a result, each of these tables may be extended by an indeterminate number of levels of organization. For example, In the case of certain state standards, broad goals may be stored as parent records to more specific performance indicators. This is illustrated in FIG. 19 where the standard “Standard 1: The student understands the different ways numbers are represented and used in the real world.” is a parent record to the more specific benchmark standard “Benchmark 1.1: The student associates verbal names, written word names, and standard numerals with the whole numbers less than 1000”. In turn, this benchmark standard (a “child” of Standard 1), is parent to the 3 grade-level expectation standards 1.1.1, 1.1.2, and 1.1.3. The grade-level expectation standards are child records of the benchmark. As a result, a varying level of specificity is preserved yet content pieces are not unnecessarily separated.

Having established these content tables, the present invention may support keyword searches. Searches may be limited to any subset of the organization hierarchy. For example, a search may be set to find only objectives in the subject “Mathematics.” These restrictions may be placed on any of the organizing fields, or alternatively any number of those fields may not be restricted. Given these restrictions on the area to be searched, records are searched based on the value of keywords entered by the user. All textual fields are available for searching, and may be limited by the user. A variety of well known full-text searching techniques, e.g., word stemming, stopword removal, content-sensitive thesauri, etc., may be used and are all appropriate in the exemplary embodiment. It may be desirable to provide a means for exact word matching (using well known techniques) in the case where stemming may inhibit the user's ability to find very specific materials.

The invention as a tool for curriculum management may define any number of application-specific tables in addition to the content and organizational tables described above Included here are three such examples. The examples are set forth for illustration purposes only and should not be construed as limiting the scope of the present invention.

A student table enables the exemplary embodiment to integrate student record keeping and to accommodate student assessment. Most important to the system will be the ability to maintain a unique student ID that may be used to link to content, assessment and other tables. Other student data may be stored as in traditional record keeping systems and may include, but is not limited to, background information, attendance, test scores, medical records, and other data.

A planner table enables the present invention to connect content and assessment to times and dates. The planner may be presented to the user as a calendar-based planning tool. By linking content to planner data, curriculum may be scheduled and a real-time history of use may be generated. Furthermore, by combining this information with student records, content may be assigned to students such as homework assignments or student tasks.

An assessment table enables the exemplary embodiment to assess the progress and performance of a student based on the content in the system. A student linked to a content piece (and possibly a planner context) can be linked to an assessment record which records their mastery of concepts, performance on tests, or other developmental information. Assessment records may be presented in a variety of formats including but not limited to numerical or letter grades, levels of mastery, free-form comments or any combination of these.

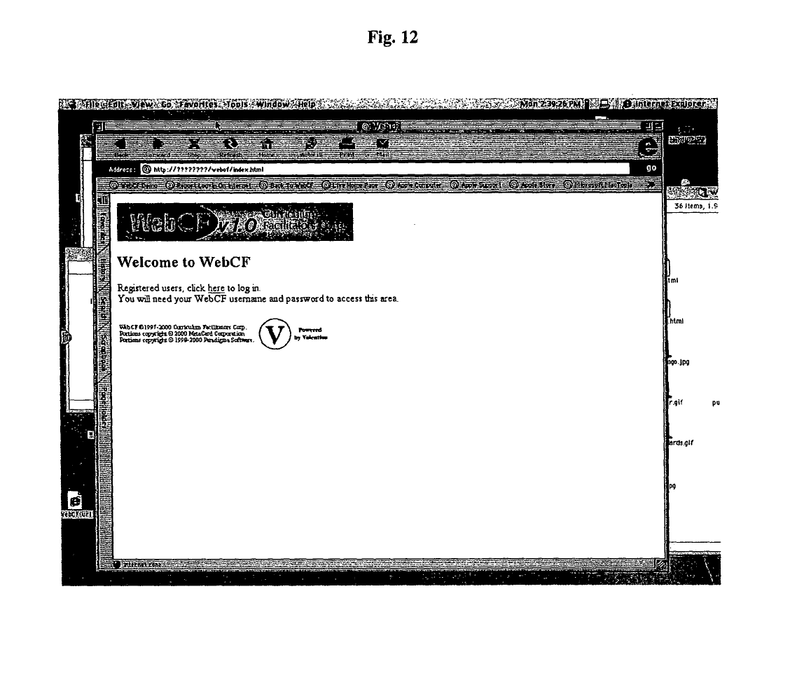

In one exemplary embodiment of a user interface to the present invention, a GUI (“Graphical User Interface”) generated as DHTML (“Dynamic Hypertext Markup Language”) by a database-connected server application is employed. Such a GUI is accessible to any user who has Internet access and an HTML browser such as Microsoft Internet Explorer, which is available from Microsoft Corporation of Redmond, Wash. FIG. 12 illustrates a user launching Internet Explorer to access the present invention, which in one exemplary embodiment, is referred to as “WebCF.”

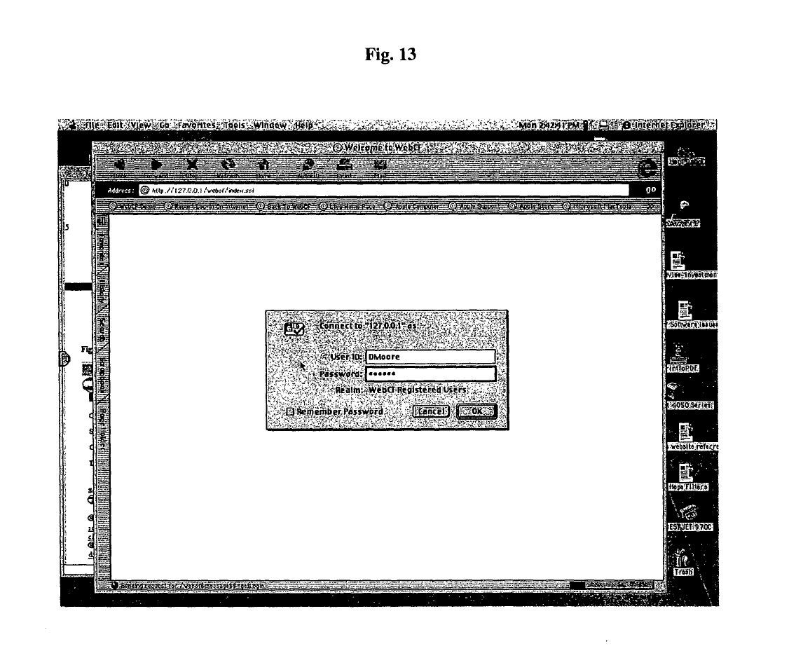

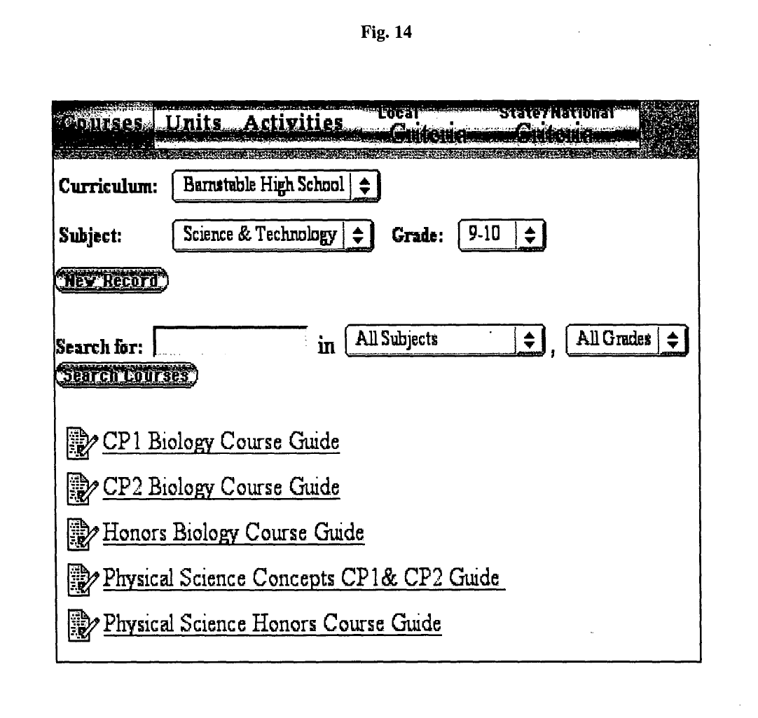

The generated GUI may provide a logon screen for the user to enter a name and password. The server application may use this name and password to verify the user's credentials, locate their preferences and return to them a first default screen. In FIG. 13, the same user from FIG. 12 is prompted within the browser to provide a name and password in order to access WebCF. Upon successful login, the user may be presented with a global navigation palette and an appropriate content area as illustrated in FIG. 14.

To browse a content area, an exemplary DHTML interface may utilize a popup menu for each level of the organizational hierarchy that subsumes the content area. For example, an interface for browsing curriculum courses may present popup menus for the purpose of selecting a subject area and grade level. An exemplary interface, which is illustrated in FIG. 14, may list each record matching the selected criteria from the popups, and make those records clickable by the user.

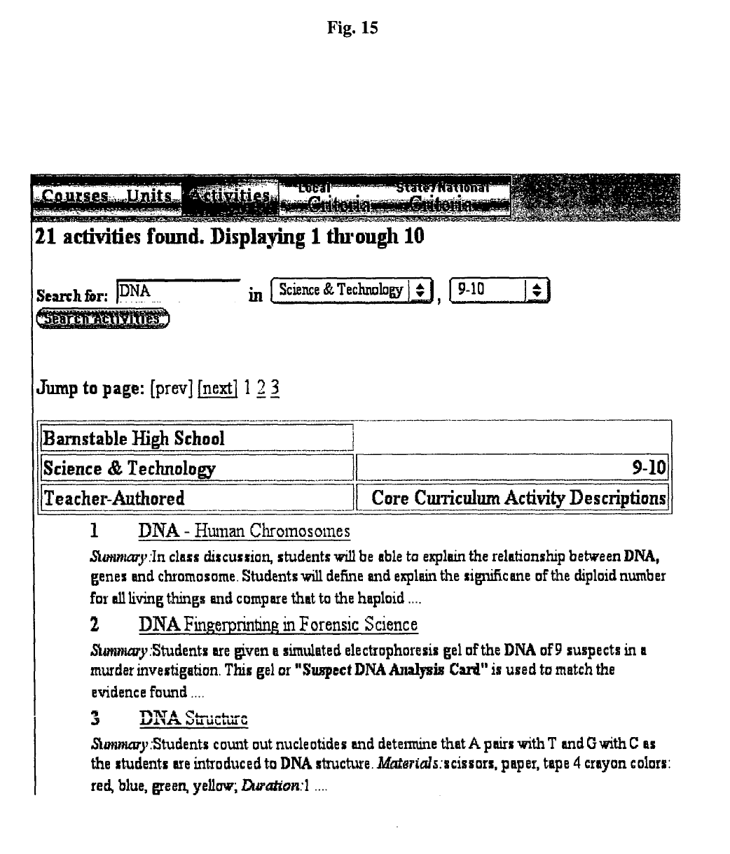

As an alternative to browsing via popups, an exemplary DHTML interface may provide an area for performing a keyword search. This area may allow the user to select limiting criteria and then enter one or more search terms. Upon triggering a keyword search, the exemplary embodiment of the invention may search the database using a variety of well-known methods for full-text searching including but not limited to word stemming and term expansion (a.k.a. thesaurus). Results may be returned in order of relevance or sorted by organizational fields. For example, as illustrated in FIG. 15, activities could be sorted by subject area and grade level or by relevancy to the search terms. Relevancy ranking is generally a feature of a find-similar tool, available. In contrast to keyword searches, a find-similar search takes as input the contents of an entire record (or possibly more than one record), and returns the “most similar” records available. Records will generally be considered similar when they contain many of the same terms, and terms may be weighted according to their uniqueness in the data as a whole. The find similar tool may incorporate any number of well-known full-text searching techniques, including but not limited to stemming, stopword removal and phrase indexing and retrieval. This find similar tool may or may not be the same tool as used in the later described automated alignment tools.

Whenever a record is listed for browsing or display as a search result, or at any other place in the exemplary GUI for one exemplary embodiment of the invention, clicking on that record name may redirect the user to an area with several more detailed options regarding that record.

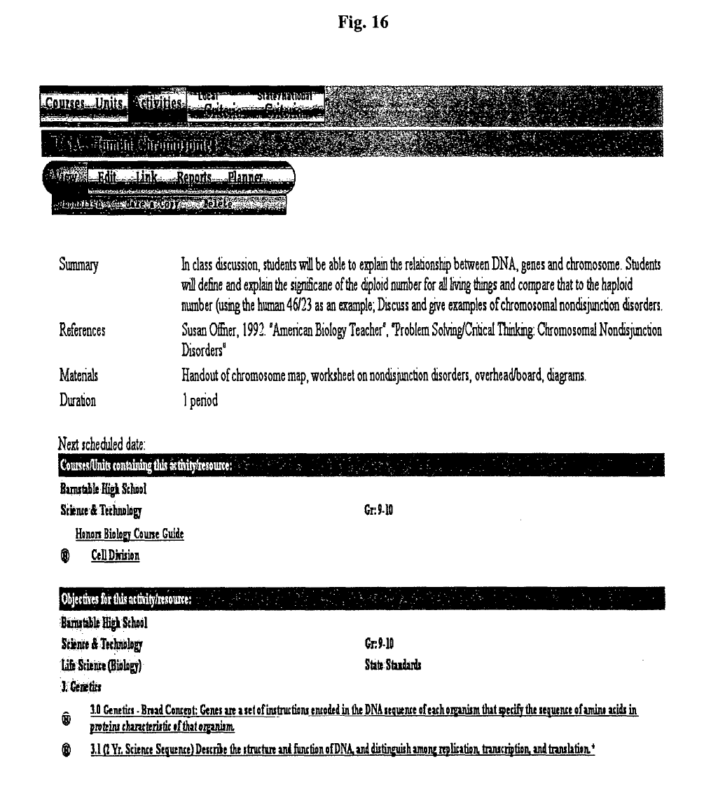

First, the exemplary embodiment may provide more detailed information about that particular record. As shown in FIG. 16, information may include but is not limited to a complete list of directly and indirectly linked records, the content of each textual field and the modification history of the record. Linked records may belong to one of the content tables, or may contain student, planner or assessment data, or may be application-specific.

Second, the exemplary embodiment may provide an area in which the user may submit changes to the textual fields of the record. The exemplary DHTML implementation may provide a standard HTML form that allows the user to choose a database field and type its contents into an HTML text field. It may be desirable to allow the user to add and remove custom named fields to the database, and to distinguish between required and optional field types. This area may be restricted to users with appropriate write access to the given record, for example, to only the record's author.

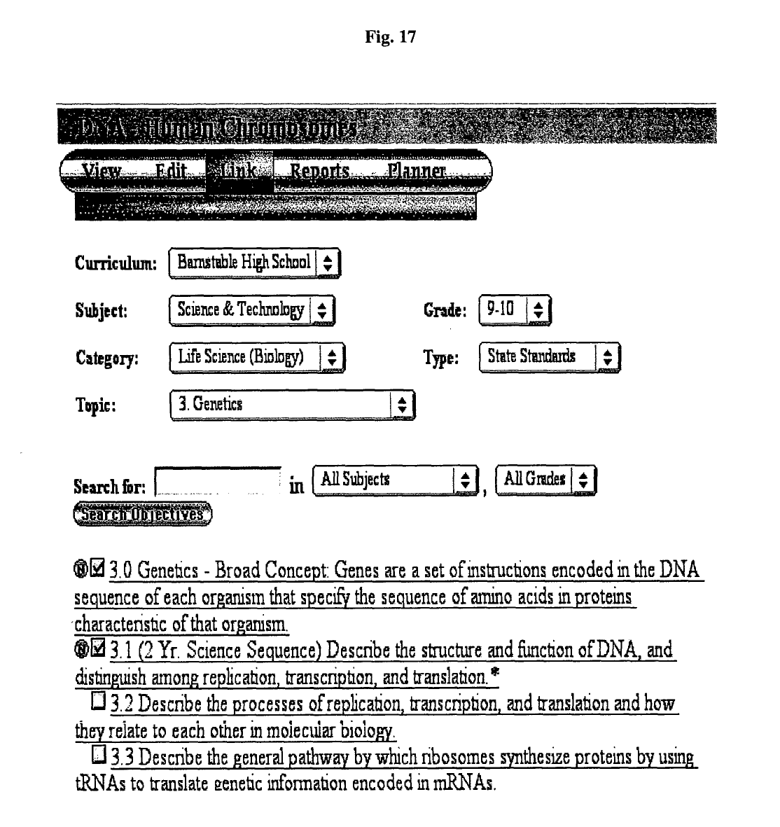

Third, the exemplary embodiment may provide an area in which the user may create links to records in other content areas. The GUI may present browsing and searching options as described previously in order to locate records to link to, while keeping the originally clicked record in focus. Links may be indicated by HTML checkboxes or other visual means as shown in FIG. 17.

Fourth, the exemplary embodiment may provide an area in which the user may request more detailed reports pertaining to the record in focus. One such report may be an unconnected records report. Such a report would display records in a selected area that are neither directly nor indirectly linked to the record in focus. For example, in the case of educational content the user may wish to determine which standards in a given area are not addressed by a course, unit or activity.

In addition to these options for a record in focus, the exemplary embodiment of the present invention may provide an area for accessing other application-specific tools. For example, in the case of educational content, there may be a calendar presented for the purpose of managing a curriculum planner. As described above and illustrated in FIG. 10, the planner may be used for scheduling of classroom content and providing a means to record student assessment and progress over time.

The exemplary embodiment may perform semi-automated alignment of curriculum materials. In the case of curriculum materials, the system is used to integrate new content into the system and provide improved organization. To integrate content, the system may find where it belongs in the existing organizational hierarchy, and locate existing record(s) to which the new content is related.

The present invention may use any of several analyses on different types of data to produce a system of integration. Among the tools are a “find-similar” tool, a “document routing” tool and a “term analysis” tool. Using these three tools, the exemplary embodiment may enable the integration of new content.

The “find-similar” tool uses the well-known technique of relevancy ranking to determine which records from a target set of records are most similar to a given record. For example, an exemplary embodiment for educational content may locate standards most similar to a new objective, and return them ranked by relevancy.

The purpose of the document routing tool is to locate an area in the target data in which a given record belongs. For example, an exemplary embodiment for educational content may be used to locate the teaching topic under which a new objective belongs. Document routing may be performed by locating the cluster or group of records that bear the highest average relevancy as would be calculated by the ordinary find-similar tool. Variations may alter the precise calculation for determining the relevancy of a cluster. For example, it may be useful to consider the relevancy of single records as zero whenever their relevancy fails to meet a minimum value. As a result, non-relevant records may not contribute to the average relevancy of a cluster. Regardless of such implementation details, the calculation will be responsible for bearing the most accurate estimation of the relevancy of clusters of records.

The “term analysis” tool uses several smaller analyses to provide information about the terms contained within a given record. Among this information may be the key term(s) from the record, the most common term(s) from the record, and terms related to but not necessarily contained within the record. Key term(s) may be defined as those terms that are most unique to that record as compared to other records in the database and/or those terms that occur most frequently. A calculation using these two properties may be used to rank terms such that the highest ranked terms are the key terms. Common terms may be defined as those terms that appear most frequently throughout other records in the database. Generally this quality of a term will inhibit its ability to be considered a key term. Related terms may be defined as those terms that occur most frequently alongside terms contained in the record to be analyzed. For example, a record containing the word “square” may not contain the word “triangle”, but “triangle” could be a related term since it may occur in other records that also contained the term “square.”

The preferred embodiment may perform simple auto-alignment using a direct alignment methodology. The system may simply take each record to be aligned, and follow a set of rules to create a best guess alignment. One such rule may be to simply create alignments to all records that receive at least a certain minimal score when considered by the find-similar tool. Other variations may include but are not limited to: a) taking the N best matches regardless of score, b) only considering records in a certain portion of the hierarchy (e.g., only consider records in “Science” for alignment to records in “Biology”), c) dynamically limiting the hierarchy using the document routing tool (e.g. only consider records in the category determined to be most relevant by the document routing tool) or d) any other application logic which limits the records to be considered and/or the minimal criteria for alignment. Generally, the GUI may allow the user to configure the analysis application to use any of these rules for alignment by toggling options and entering criteria. It may be desirable to allow the user to browse live data to determine the proper options. In the case where the rules have been fixed, a GUI may not be needed.

The analysis application may wish to incorporate user feedback into the process of auto alignment, whereby alignments pend approval or rejection by the user. Greater control of individual analysis tools may be made available to the user such that the user may effectively seek out proper alignments in a less automated fashion when desired.

One possible implementation of such a feedback-based system would be to run a completely automated alignment as described previously, however, alignments would not be saved directly to the database but rather accumulated for review as a suggested alignment. As the user proceeds through each record of the to-be-aligned content, he/she may be given the option to accept completely the suggested links and commit them to the database, or to make modifications.

Methods of modification may include but are not limited to a) removing unsatisfactory alignments through the use of a “remove” function, or b) adding new alignments by locating manually the record(s) to be aligned. To accomplish b), the GUI may allow the user to perform several functions, such as: a) browsing of the data via the organizational hierarchy, b) ordinary keyword searching of the data, c) execution of find-similar searches or document routing requests, or d) execution of term analysis tools. In particular, c) and d) may be used to analyze records other than the source record being aligned. For example, the user may wish to perform a find-similar search on a record successfully aligned to the source record, rather than on the source record itself. An exemplary GUI may allow the use of any of these tools on any record visible on the screen, and/or may accept a user's textual input in lieu of a database record. Upon processing a document routing request, the analysis application locates a portion of the organizational hierarchy that is of interest to the user. The GUI may automatically configure the appropriate data browser to display that area of the hierarchy, since the user may be interested in the contents of said hierarchy, not solely the description of the hierarchy.

As previously stated, the invention is not based in any one alignment paradigm; rather it is a general tool to enable many.

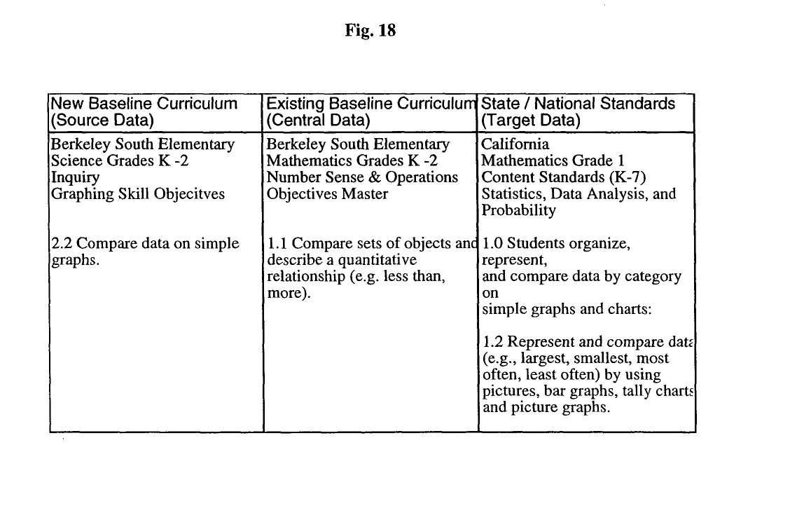

For example, in another exemplary embodiment of the present invention, the processes for automated and manual direct alignment may be extended to facilitate indirect alignment. In the indirect alignment paradigm, the GUI for the embodiment may, for example, present three sets of data: the source data, the central data, and the target data. The exemplary data sets are illustrated in FIG. 18. In indirect alignment, new alignments are made to a central database, which has been pre-aligned to target data. Thus, alignments are inherited by a transitive property: if record A in the source data is linked to record B in the central database, and record B is linked to a record C in the target data, then A is considered to be aligned to C. The present invention may support this process by extension from the direct alignment model. In effect, the user proceeds as normal for a direct alignment between the source data and the central database. The GUI may display existing alignments between the central and target databases as alignments between the source and central databases are made. This may provide further guidance for the user when/if he/she chooses to manually review the alignments made between the source and central databases. In this paradigm, whenever the user commits alignments between the source and central databases, indirect alignments between the source and target are made by definition through inheritance.

Extending the tools of the analysis application to a more general system reveals the ability to support many additional alignment methodologies. This can be done by manipulating the types of data that are present in each data set, how many data sets are available, which sets are linked directly, which sets are linked indirectly, and how much of the alignment is automated.

Manipulating the data types used in each data set can result in different processes. For example, the user may set the source data set and the central data set to the same data type, where the central data has already been aligned to target data, while the source data has not. If the user proceeds as in an indirect alignment tool with manual intervention, the system produces a set of suggested alignments between the source data and the central data. In the pure indirect alignment model, the user would then review these alignments and the alignment to the target data would be created automatically through inheritance. However, in this new model where the source and central data sets are of the same data type, the GUI may present the inherited links as those that are suggested for review. That is, if record A from the source data has a suggested alignment to record B in the central data which is aligned to record C in the target data, the system will present a reviewable link between A and C (rather than reviewing the link between A and B as in pure indirect alignment). Upon reviewing these alignments, which were initially found via the central data set, a direct alignment could be made between the source and target data. Thus, the central data would have been used as a guiding force with no additional alignments having been made to it. Furthermore, since the source and central data sets are of the same data type, it may be desirable to integrate the two and thus produce an enriched central data set, which may be used for the next alignment. In this fashion, the quality of the system may improve over time.

Many more iterations of these methods can be generated by extension For example, there could be N central data sets, each aligned in succession to each other. Each level of alignments could be inherited automatically or manually reviewable. The system may support multiple target data sets, in which case the alignment processes would simply be iterated for each available target data set. It is worth noting that this is very similar to adding one more level to the organization hierarchy of the target data—if there were N target data sets, one could imagine a top level organization field dubbed “Target Data Set Number” with the values 1 . . . N. Support for multiple source data sets is equally simple—they can be iterated one at a time or imagined as subsets of a larger hierarchy with a “Source Data Set Number” field. Multiple source or target data sets could also be processed in order depending on data type. For example, if data types are aligned in the order {A, B, C, . . . Z} and the system is given source data sets of types (A, B, C) to align to target data of type D, it may be desirable to first align C to D, then B to C, then A to B (or the reverse order). The possible combinations are unlimited, and may describe any such modular alignment task.

Although the invention has been described and illustrated in the foregoing exemplary embodiments, it is understood that the present disclosure has been made only by way of example, and that numerous changes in the details of construction and combination and arrangement of processes and equipment may be made without departing from the spirit and scope of the invention.

What is claimed:

1. A method for managing content, wherein at least a portion of the content is stored by an alignment system, the method comprising the steps of:
receiving a request, from at least one user, at the alignment system, to align the content to at least one of a plurality of standards using the alignment system; and
performing the alignment using the alignment system.

2. The method of claim 1, wherein the alignment system is a web-based alignment system.

3. The method of claim 1, wherein the alignment system is a software-based alignment system.

4. The method of claim 1, wherein the content comprises at least one of instructional data, planning data, implementation data, assessment data, school district instructional data, school district planning data, and school district assessment data.

5. The method of claim 1, wherein the step of performing the alignment of the content is a semi-automated process performed by the alignment system.

6. The method of claim 1, wherein the plurality of standards comprises local school standards, school district standards, state standards, and national standards.

7. The method of claim 1, wherein the plurality of standards comprises national marketing standards.

8. The method of claim 1, wherein the alignment method aligns the content by integrating new content into an existing organizational hierarchy within the alignment system by determining where the new content belongs within the existing organizational hierarchy and by locating at least one existing record to which the new content is related.

9. The method of claim 8, wherein the alignment system comprises a relational database management system.

10. The method of claim 8, wherein the step of integrating new content is achieved using at least one of a find-similar tool, a document routing tool, and a term analysis tool.

11. The method of claim 1, wherein the alignment is performed based on a set of rules, the set of rules comprising at least one of creating alignments to all records that receive at least a minimal score when considered by a find-similar tool, taking a predetermined number of best matches regardless of score, considering records in a certain portion of an organization hierarchy, dynamically limiting the organizational hierarchy using a document routing tool, a logic application which limits at least one of a number of records to be considered and a minimal criteria for alignment.

12. The method of claim 1, wherein the step of aligning the content further comprises receiving feedback from the at least one user, wherein the feedback enables the at least one user to do at least one of accept, reject, and modify an alignment result.

13. The method of claim 1, wherein the step of performing the alignment further comprises performing one of direct alignment and indirect alignment.

14. The method of claim 13, wherein indirect alignment is achieved by manipulating data types, such that alignment is made directly between at least one source data set and at least one target data set without initial alignment between the at least one source data set and at least one central data set.

15. The method of claim 14, wherein at least one new central data set is achieved by integrating the at least one source data set and the at least one central data set.

16. A system for managing content comprising:
a relational database management system, which comprises a first plurality of data tables, wherein the first plurality of data tables comprises at least part of the content;
at least one server in communication with the relational database management system, wherein the server controls access to the relational database management system and at least one of retrieval of and modification to the content contained in the first plurality of data tables; and
an interface that receives a request from at least one user to access the relational database management system, wherein the interface receives the request from the at least one user over a wide area network.

17. The system of claim 16, wherein the content comprises at least one of instructional data, planning data, implementation data, assessment data, school district instructional data, school district planning data, and school district assessment data.

18. The system of claim 16, wherein each one of the first plurality of data tables is related to each other in a many-to-many database relationship.

19. The system of claim 16, wherein individual ones of the first plurality of data tables contain at least one record.

20. The system of claim 19, wherein the at least one record comprises a plurality of information, the information comprising at least one of a record name, an identification field, and at least one open-ended text field.

21. The system of claim 16, wherein the first plurality of data tables further comprises a second plurality of data tables, which comprises organizational information for categorizing the content.

22. The system of claim 21, wherein the first plurality of data tables and the second plurality of data tables are arranged in a hierarchical relationship such that the first plurality of data tables is subordinate to the second plurality of data tables.

23. The system of claim 22, wherein each one of the second plurality of data tables is related to the first plurality of data tables in a one-to-many relationship.

24. The system of claim 21, wherein the second plurality of data tables further comprises a third plurality of data tables, which comprises organizational information for categorizing the content, and wherein the first plurality of data tables, the second plurality of data tables, and the third plurality of data tables are arranged in a hierarchical relationship such that the third plurality of data tables is subordinate to the second plurality of data tables and the first plurality of data tables is subordinate to the third plurality of data tables.

25. The system of claim 29, wherein each one of the second plurality of data tables is related to the third plurality of data tables in a one-to-many relationship.

26. A computer-readable medium having a set of computer-executable instructions for managing content, the instructions comprising:
receiving a request from at least one user to align the content to at least one a first plurality of standards using a alignment system, wherein the alignment system stores the content; and
performing the alignment using the alignment system.

27. The computer-readable medium of claim 26 wherein the content comprises at least one of instructional data, planning data, implementation data, assessment data, school district instructional data, school district planning data, and school district assessment data.

28. The computer-readable medium of claim 26, wherein performing the alignment of the content is a semi-automated process performed by the alignment system.

29. The computer-readable medium of claim 26, wherein the content is aligned by integrating new content into an existing organizational hierarchy within the web-based method by determining where the new content belongs within the existing organizational hierarchy and by locating at least one existing record to which the new content is related.

30. The computer-readable medium of claim 29, wherein the alignment is performed using a relational database management system.

31. The computer-readable medium of claim 29, wherein integrating new content is achieved using at least one of a find-similar tool, a document routing tool, and a term analysis tool.

32. The computer-readable medium of claim 26, wherein the alignment is performed based on a set of rules, the set of rules comprising at least one of (a) creating alignments to all records that receive at least a minimal score when considered by a find-similar tool, (b) taking a predetermined number of best matches regardless of score, considering records in a certain portion of an organization hierarchy, (c) dynamically limiting the organizational hierarchy using a document routing tool, and (d) limiting at least one of a number of records to be considered and a minimal criteria for alignment.

33. The computer-readable medium of claim 26, wherein the instruction for aligning the content further comprises receiving feedback from the at least one user, wherein the feedback enables the at least one user to do at least one of accept, reject, and modify an alignment result.

34. The computer-readable medium of claim 26, wherein the performing the alignment further comprises performing one of direct alignment and indirect alignment.

35. The computer-readable medium of claim 29, wherein indirect alignment is achieved by manipulating data types, such that alignment is made directly between at least one source data set and at least one target data set without initial alignment between the at least one source data set and at least one central data set.

36. The computer-readable medium of claim 30, wherein at least one new central data set is achieved by integrating the at least one source data set and the at least one central data set.

37. The computer-readable medium of claim 26, wherein the alignment system stores all of the content to be aligned.

38. The computer-readable medium of claim 26, wherein the alignment system stores a portion of the content to be aligned and additionally stores at least one uniform resource identifier link, which enables access to additional portions of the content to be aligned, the additional portions of the content being stored on at least one of at least one separate computer and at least one separate server.
